(19) United States
(12) Patent Application Publication
(10) Pub. No.: US 2015/0171638 A1
(43) Pub. Date: Jun. 18, 2015

(54) CHARGER FOR RECHARGEABLE BATTERY AND CHARGING METHOD THEREOF

(71) Applicant: Go-Tech Energy Co., Ltd., New Taipei City (TW)

(72) Inventor: Pao-Sheng HUANG, MiaoLi County (TW)

(73) Assignee: GO-TECH ENERGY CO., LTD., New Taipei City (TW)

(21) Appl. No.: 14/105,430

(22) Filed: Dec. 13, 2013

(51) Int. Cl. H02J 7/00

(52) U.S. Cl. CPC H02J 7/007; H02J 7/0052; H02J 7/0021

(57) ABSTRACT

A charger and charging method for rechargeable batteries are disclosed. The charging method includes steps of: setting an exceeding amount regarding a battery information; continuously receiving the battery information from a battery management system in each rechargeable battery; continuously sorting values of the battery information from every battery management units; charging the rechargeable battery having the minimal value of the battery information; stopping charging the rechargeable battery when the latest value of the battery information of the rechargeable battery under charge becomes maximum and exceeds the value of the battery information of the rechargeable battery ranked second up to the exceeding amount; and charging the rechargeable battery having the minimal value of the battery information in the latest sorting.

### FIELD OF THE INVENTION

The present invention relates to a charger and charging method. More particularly, the present invention relates to a charger and charging method for rechargeable batteries charged alternatively.

### BACKGROUND OF THE INVENTION

Rechargeable batteries are widely used in many products, such as notebooks, tablets, mobile phones, and even large electric vehicles and robots. Although a rechargeable battery is composed of a number of rechargeable battery cells linked in series or parallel, according to different power supply targets, there are different specifications of output current and voltage.

Generally, electric vehicles use several identical rechargeable batteries which have large current as the power source. Due to popularization of electric vehicles, many charging stations, including large home-use charging devices, are gradually set up around people's lives. Those devices can directly charge all the rechargeable batteries in an electric vehicle. The charging method is to apply multi-charging devices to one rechargeable battery. There are two issues. First, state of charge in each rechargeable battery in charge is not the same. When one rechargeable battery finishes charging, other rechargeable batteries still don't finish yet. The whole battery set is going to work (discharge). It is easy to make the power of an electric vehicle can not reach its target. Second, the charging device needs more AC-DC and distribution circuits. It causes higher cost on manufacturing the devices.

Therefore, nowadays, there are charging devices using one set of AC-DC current and distribution circuit to charge rechargeable batteries, respectively, applied in the market. In order to save money on building-up, those charging devices can be used for rechargeable batteries of large electric equipment, such as electric vehicles, which have long charging time so that charging during off-peak can be possible. Charging cost can be saved as well.

Although there are many advantages mentioned above, the aforementioned charging device still needs to overcome a problem: how to control every rechargeable battery to increase state of charge in a consistent path (even charge) during charging? To this end, a prior art might have shown a possible direction to settle this problem. Please see FIG. 1. A charge-discharge circuit 1 can reduce power consumption between charging and discharging without reducing using time of the battery. The charge-discharge circuit 1 includes: a charging current control circuit 2, connected to rechargeable batteries 3 in parallel. It is used to carry out a bypass control which is for charging current and applied to the rechargeable batteries 3. A potential difference detecting circuit 4 detects voltage difference between rechargeable batteries 3. According to the voltage difference, the charging current control circuit 2 gets controlled so that it is possible to bypass the charging current applied to the rechargeable batteries 3, selectively.

The technique uses voltage difference between rechargeable batteries as a basis for bypass control during charging and sets threshold values of voltage for triggering and cut-off charging. It is a good way to control every rechargeable battery to evenly be charged during charging. However, since chargeable power of the rechargeable batteries may vary with time, the measured voltage difference can only indicate current situation of the rechargeable batteries. It is not able to reflect real charging situation of the rechargeable batteries. Meanwhile, with development of technologies, development of battery management systems has matured. More characteristics of the rechargeable batteries can be obtained to improve management of charging. Hence, implementation skills of the aforementioned technique need to be sophisticated to fulfill the requirement in practice.

Therefore, a method and corresponding charger which can control every rechargeable battery to increase state of charge in a consistent path (even charge) during charging are still desired.

### SUMMARY OF THE INVENTION

The known charging equipment for multi-rechargeable batteries costs high because there are many AC-DC and distribution circuits. The charging equipment utilizing only one AC-DC and distribution circuit can charge the rechargeable batteries, too. Therefore, a method and a charger made thereby which can control each rechargeable battery when charged so as to increase state of charge of each rechargeable battery (evenly charged) is desired. The charging method and charger according to present invention can fulfill the above requirement.

According to an aspect of the present invention, a charger for rechargeable batteries: a power switching device, connected to an AC power, for transforming alternating current from the AC power into fixed output direct current to charge one rechargeable battery per charging; a number of charging devices, each charging device includes: a charge switching unit, connected to the power switching device, for conducting the direct current from the power switching device after receiving a conducting signal; an anti-reverse charge unit, connected to the charge switching unit, receiving and conducting the direct current from the charge switching unit, for preventing reversely charging from a rechargeable battery to a charge switching unit after the rechargeable battery finishes charging; and an output unit, connected to the anti-reverse charge unit, for charging the rechargeable battery with the direct current from the anti-reverse charge unit; and a charging control device, electrically connected to a battery management system in each rechargeable battery connected with the output unit, for continuously receiving a battery information from the battery management system, judging which rechargeable battery should be charged and sending the conducting signal to the charge switching unit of the charging device connected with the rechargeable battery which should be charged. The charging control device continuously processes sorting to values of the battery information from every battery management units, the charging device charges the rechargeable battery which has the minimal value of the battery information until the latest value of the battery information of the rechargeable battery under charge becomes maximum and exceeds the value of the battery information of the rechargeable battery ranked second up to an exceeding amount, and the rechargeable battery having the minimal value of the battery information in the latest sorting begins to be charged.

Preferably, the conducting signal is a voltage value.

Preferably, the battery information is state of charge or voltage.

Preferably, the charge switching unit is composed of a diode and a Metal-Oxide-Semiconductor Field-Effect Transistor (MOSFET) connected in parallel and a gate of the MOSFET is controlled by the conducting signal.

Preferably, the anti-reverse charge unit is composed of a diode and a MOSFET connected in parallel and a gate of the MOSFET is controlled by direct current voltage from the charge switching unit.

According to another aspect of the present invention, a method for charging a plurality of rechargeable batteries, comprising the steps of: setting an exceeding amount regarding a battery information; continuously receiving the battery information from a battery management system in each rechargeable battery; continuously sorting values of the battery information from every battery management units; charging the rechargeable battery having the minimal value of the battery information; stopping charging the rechargeable battery when the latest value of the battery information of the rechargeable battery under charge becomes maximum and exceeds the value of the battery information of the rechargeable battery ranked second up to the exceeding amount; and charging the rechargeable battery having the minimal value of the battery information in the latest sorting.

Preferably, the battery information is state of charge or voltage.

The charging method and charger according to the present invention can charge the rechargeable batteries alternatively. Charge amount is controllable. The result leads to evenly charge of all rechargeable batteries until they are all fully charged. There is no over-charge or non-full charge.

### BRIEF DESCRIPTION OF THE DRAWINGS

FIG. 1 is a block diagram of a prior art of a charge-discharge circuit for a battery.

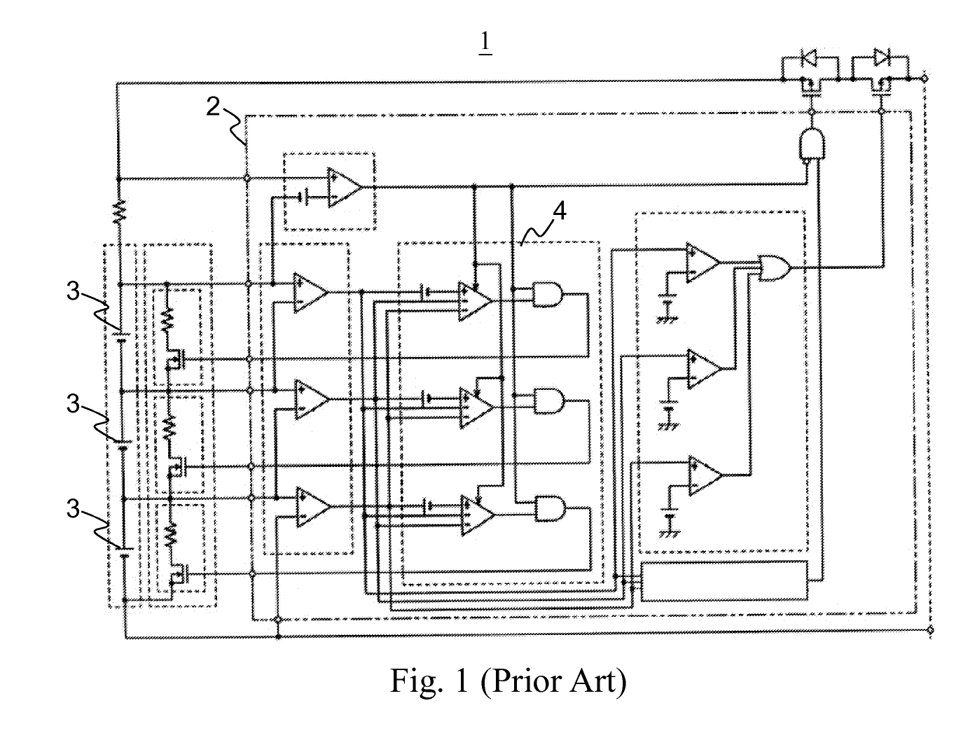

FIG. 2 is a block diagram of a charger according to the present invention.

FIG. 3 is a detailed circuit design of the charger.

FIG. 4 is a flow chart of a charging method according to the present invention.

FIG. 5 illustrates variation of state of charge of each rechargeable battery with time according to the charging method.

### DETAILED DESCRIPTION OF THE PREFERRED EMBODIMENT

The present invention will now be described more specifically with reference to the following embodiment.

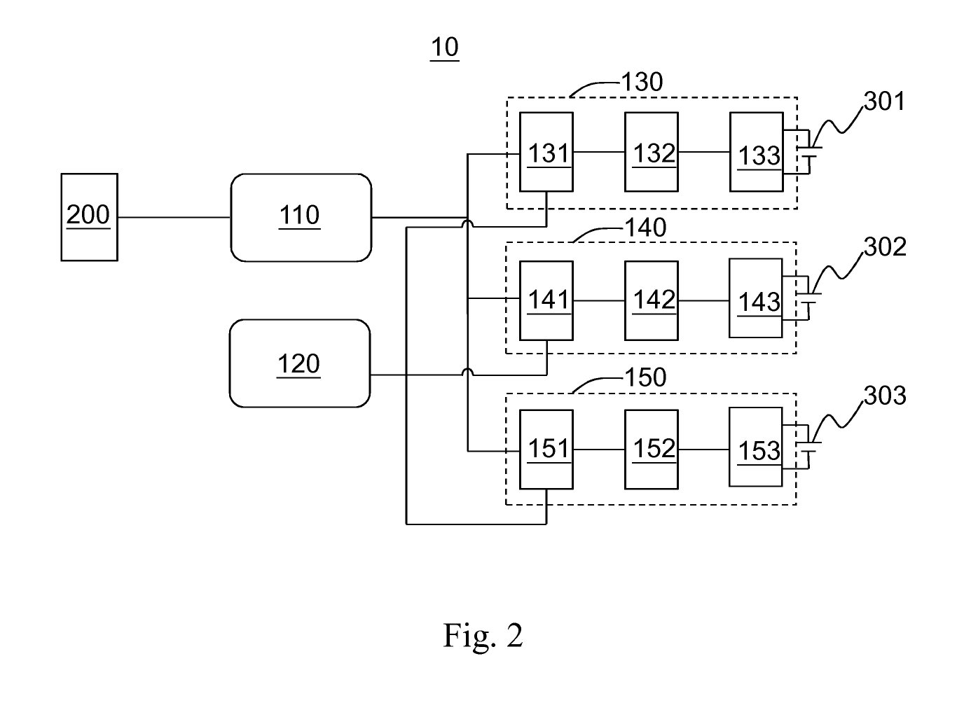

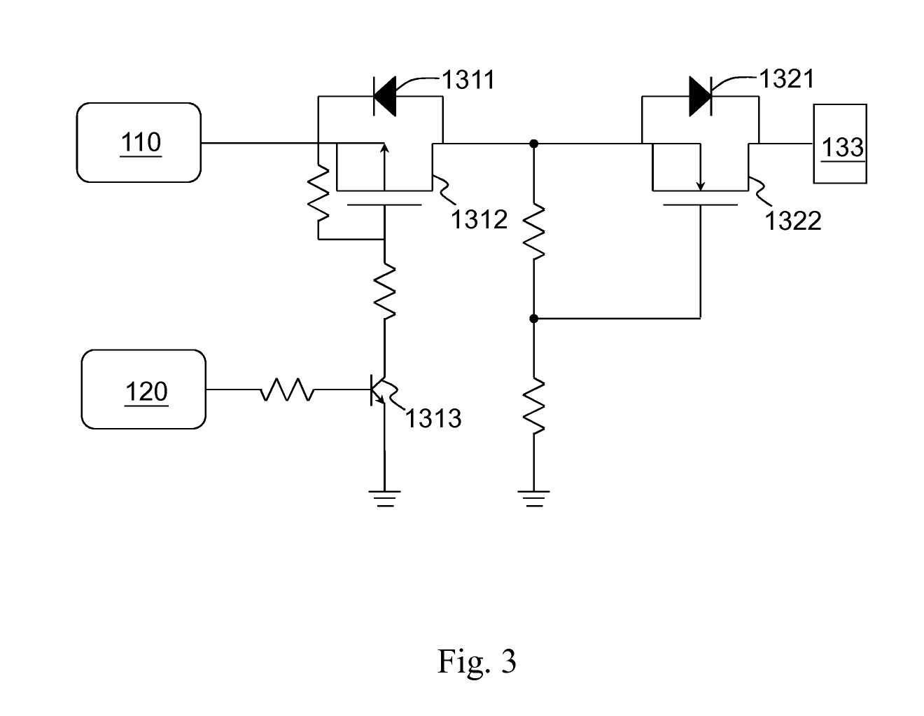

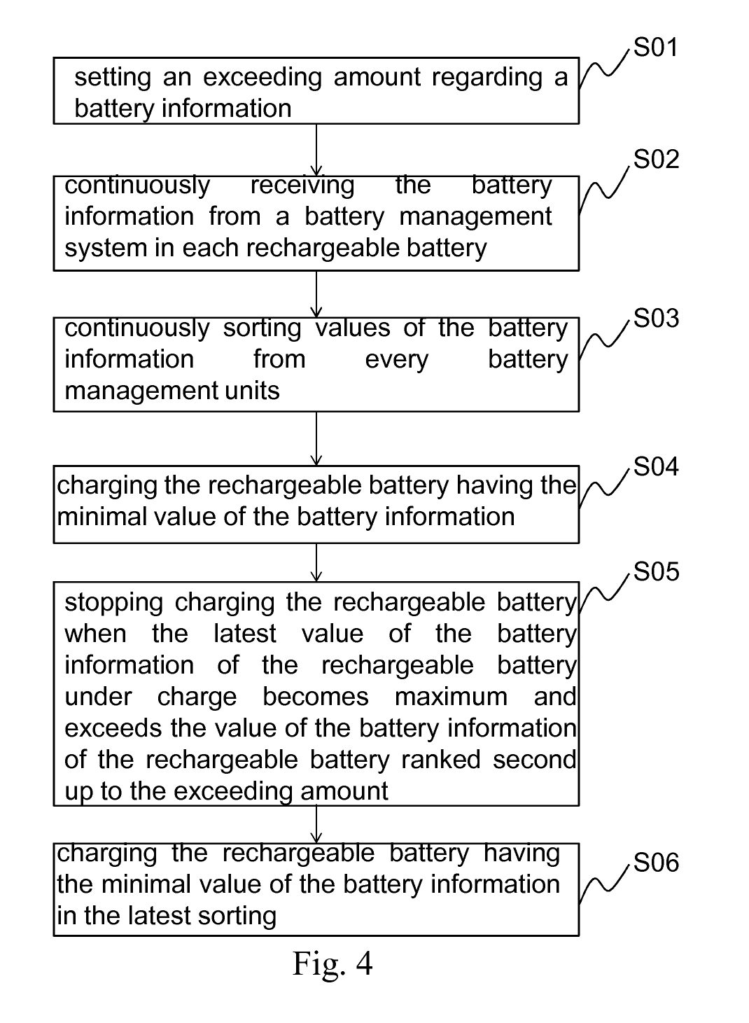

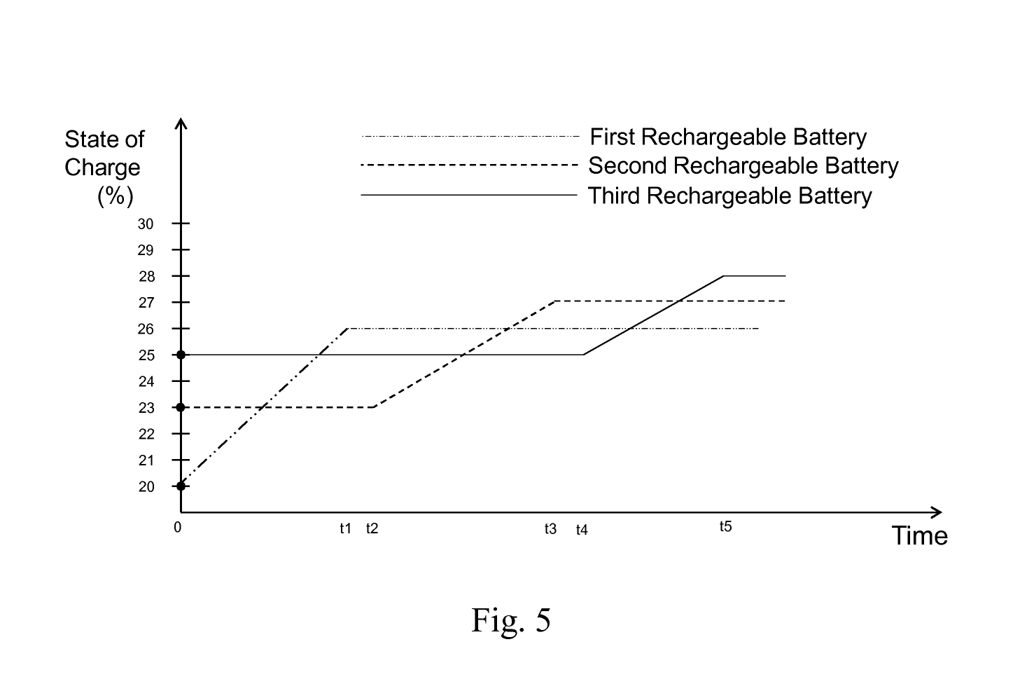

Please refer to FIG. 2 to FIG. 5. FIG. 2 is a block diagram of a charger according to the present invention. FIG. 3 is a detailed circuit design of the charger. FIG. 4 is a flow chart of a charging method according to the present invention. FIG. 5 illustrates variation of state of charge of each rechargeable battery with time according to the charging method.

A charger 10 for rechargeable batteries provided by the present invention is composed of one power switching device 110, three charging devices (a first charging device 130, a second charging device 140 and a third charging device 150) and a charging control device 120. According to the spirit of the present invention, the number of the charging devices is not limited to three. At least two charging devices are workable. Three charging devices in the present embodiment are used to illustrate a more complex situation of charging order. It should be notice that the purpose of the embodiment is not to limit the quantity of charging devices.

The power switching device 110 is connected to an AC power 200 for transforming alternating current from the AC power 200 into fixed output direct current. It can charge one rechargeable battery per charging. In the present embodiment, the AC power 200 is an output of the mains supply (mains supply outlet). In practice, it can also be a power generator. Any equipment or device able to provide alternating current is the AC power that the present invention claims. In the present embodiment, a preferable fixed output direct current is with 48V and 10 A. Because large electrical machines, such as electrical vehicles, need larger current from the rechargeable batteries to drive comparing with smaller ones, the fixed output direct current for the large electrical machines needs to be at least 10 A in design. Current value falls between 10 A to 20 A is preferred.

Each charging device includes a charge switching unit, an anti-reverse charge unit and an output unit. That is, a first charging device 130 includes a first charge switching unit 131, a first anti-reverse charge unit 132 and a first output unit 133; a second charging device 140 includes a second charge switching unit 141, a second anti-reverse charge unit 142 and a second output unit 143; a third charging device 150 includes a third charge switching unit 151, a third anti-reverse charge unit 152 and a third output unit 153. The first charge switching unit 131, second charge switching unit 141 and third charge switching unit 151 are connected to the power switching device 110. They can conduct the direct current from the power switching device 110 after receiving a conducting signal, respectively. Here, the conducting signal is a preset voltage value. Operation of the conducting signal will be illustrated later with reference of FIG. 3.

The first anti-reverse charge unit 132, second anti-reverse charge unit 142 and third anti-reverse charge unit 152 are connected to the first charge switching unit 131, second charge switching unit 141 and third charge switching unit 151, respectively. They can receive and conduct the direct current from the charge switching units, respectively. The purpose of the charge switching unit is to prevent reversely charging from a rechargeable battery to a charge switching unit after the rechargeable battery finishes charging

The first output unit 133, second output unit 143 and third output unit 153 are connected to the first anti-reverse charge unit 132, second anti-reverse charge unit 142 and third anti-reverse charge unit 152, respectively. Each output unit can charge the rechargeable battery linked thereto with the direct current from the corresponding anti-reverse charge unit. Please refer to FIG. 2. The first output unit 133 charges a first rechargeable battery 301. The second output unit 143 charges a second rechargeable battery 302. The third output unit 153 charges a third rechargeable battery 303.

Each charge switching unit (the first charge switching unit 131, second charge switching unit 141 and third charge switching unit 151) has the same structure and functions. Each anti-reverse charge unit (the first anti-reverse charge unit 132, second anti-reverse charge unit 142 and third anti-reverse charge unit 152) has the same structure and functions, too. Take the first charge switching unit 131 and first anti-reverse charge unit 132 as an example to illustrate the internal structure and the operation. Please refer to FIG. 3. The first charge switching unit 131 is composed of a diode 1311 and a Metal-Oxide-Semiconductor Field-Effect Transistor (MOSFET) 1312 connected in parallel. A gate of the MOSFET 1312 is controlled by the conducting signal. The voltage of conducting signal is applied to a base of a triode 1313. A forward bias is formed, further conducting the power switching device 110 and first anti-reverse charge unit 132. On the contrary, if there is no conducting signal, the conduction is off Here, the MOSFET 1312 is a P-channel MOSFET with its drain connected to an anode of the diode 1311.

Also, the first anti-reverse charge unit 132 is composed of a diode 1321 and a MOSFET 1322 connected in parallel. A gate of the MOSFET 1322 is controlled by the direct current voltage from the charge switching unit. Here, the MOSFET 1322 is an N-channel MOSFET with its source connected to an anode of the diode 1321. When the direct current from the power switching device 110 is received, the first anti-reverse charge unit 132 can conduct the power to the first output unit 133, further charging the first rechargeable battery 301. On the contrary, if it is not under charge, the first anti-reverse charge unit 132 can prevent reversely charging from the first rechargeable battery 301 to the first charge switching unit 131 after the first rechargeable battery 301 finishes charging.

The charging control device 120 is electrically connected to a battery management system (not shown) in each rechargeable battery (the first rechargeable battery 301, second rechargeable battery 302 and third rechargeable battery 303) for continuously receiving battery information from the battery management systems. Here, it is not limited that what kind of battery management system can be used. However, the battery management system used should continuously detect and send the battery information. According to the present invention, the battery information is the state of charge of the rechargeable battery; under current regulation phase of the rechargeable battery, the battery information may be a voltage value. The charging control device 120 judges which rechargeable battery should be charged and sends the conducting signal to the charge switching unit of the charging device connected with the rechargeable battery which should be charged. For example, if the charging control device 120 judges that the second rechargeable battery 302 is going to be charged, the conducting signal will be sent to the second charge switching unit 141.

A charging method according to the present invention is disclosed below. Please refer to FIG. 4 and FIG. 5 at the same time. First, the values of the state of charge measured by the battery management systems in the rechargeable batteries are: the first rechargeable battery 301 is 20%, the second rechargeable battery 302 is 23%, and the third rechargeable battery 303 is 25%. Since the charging control device 120 continuously receives the values of the state of charge detected by every battery management systems (the battery information is state of charge in the present embodiment; in fact, it can be voltage), the values may vibrates within a very small range. The aforementioned values are measured for the judgment before charging processes.

Before charging starts, an exceeding amount regarding the battery information is set (S01). In the present embodiment, the exceeding amount is one percent. It means that when state of charge of some rechargeable battery exceeds state of charge of a compared rechargeable battery up to one percent, the charging control device 120 will take some action. The charging control device 120 continuously receives the battery information from a battery management system in each rechargeable battery (S02). Thus, the charging control device 120 will sort the values of the battery information from every battery management units (S03). The result of sorting before charging is: the value of state of charge of the third rechargeable battery 303>the value of state of charge of the second rechargeable battery 302>the value of state of charge of the first rechargeable battery 301.

Now, the first charging device 130 charges the first rechargeable battery 301 which has the minimal value of the state of charge (S04) until the latest value of the state of charge of the first rechargeable battery 301 under charge becomes maximum and exceeds the value of the battery information of the third rechargeable battery 303 ranked second up to one percent (exceeding amount) (S05). Now, time goes to t1. The newest state of charge of the first rechargeable battery 301 is 26%, higher than the third rechargeable battery 303 ranked second by one percent (please notice that sorting of the values of state of charge continuously processes). After the charging control device 120 change the charging target, at t2, it begins to charge the rechargeable battery having the minimal value of the battery information in the latest sorting. At t2, the newest sorting result is the value of state of charge of the first rechargeable battery 301>the value of state of charge of the third rechargeable battery 303>the value of state of charge of the second rechargeable battery 302. Hence, the second charging device 140 charges the second rechargeable battery 302 which has the minimal value of state of charge. When time goes to t3, the state of charge of the second rechargeable battery 302 becomes 27%. It hss the maximum value and exceeds the third rechargeable battery 303 ranked second one percent. The second rechargeable battery 302 stops charging. Similarly, after the charging control device 120 changes the charging target, at t4, begins to charge the rechargeable battery (now, it is the third rechargeable battery 303) having the minimal value of the battery information in the latest sorting until the next exceeding amount comes out at t5.

It can be seen from above that three rechargeable batteries can be charged by turns according to the charging method and charger provided by the present invention. Charge amount is controllable (by the exceeding amount). The result leads to evenly charge of all rechargeable batteries until they are all fully charged. There is no over-charge or non-full charge. It is worth noting that the timings in FIG. 5 are for illustration. Usually, it takes very short time for the charging control device 120 to change charge target. For example, time interval between t2 and t3 is much longer than that between t1 and t2. They are not used to limit the charging time in the present invention.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A charger for rechargeable batteries, comprising:
a power switching device, connected to an AC power, for transforming alternating current from the AC power into fixed output direct current to charge one rechargeable battery per charging;
a plurality of charging devices, each charging device comprising:
a charge switching unit, connected to the power switching device, for conducting the direct current from the power switching device after receiving a conducting signal;
an anti-reverse charge unit, connected to the charge switching unit, receiving and conducting the direct current from the charge switching unit, for preventing reversely charging from a rechargeable battery to the charge switching unit after the rechargeable battery finishes charging; and
an output unit, connected to the anti-reverse charge unit, for charging the rechargeable battery with the direct current from the anti-reverse charge unit; and
a charging control device, electrically connected to a battery management system in each rechargeable battery connected with the output unit, for continuously receiving a battery information from the battery management system, judging which rechargeable battery should be charged and sending the conducting signal to the charge switching unit of the charging device connected with the rechargeable battery which should be charged,
wherein, the charging control device continuously processes sorting values of the battery information from every battery management units, the charging device charges the rechargeable battery which has the minimal value of the battery information until the latest value of the battery information of the rechargeable battery under charge becomes maximum and exceeds the value of the battery information of the rechargeable battery ranked second up to an exceeding amount, and the rechargeable battery having the minimal value of the battery information in the latest sorting begins to be charged.

2. The charger according to claim 1, wherein the conducting signal is a voltage value.

3. The charger according to claim 1, wherein the battery information is state of charge or voltage.

4. The charger according to claim 1, wherein the charge switching unit is composed of a diode and a Metal-Oxide-Semiconductor Field-Effect Transistor (MOSFET) connected in parallel and a gate of the MOSFET is controlled by the conducting signal.

5. The charger according to claim 1, wherein the anti-reverse charge unit is composed of a diode and a MOSFET connected in parallel and a gate of the MOSFET is controlled by direct current voltage from the charge switching unit.

6. A method for charging a plurality of rechargeable batteries, comprising the steps of:
setting an exceeding amount regarding a battery information;
continuously receiving the battery information from a battery management system in each rechargeable battery;
continuously sorting values of the battery information from every battery management units;
charging the rechargeable battery having the minimal value of the battery information;
stopping charging the rechargeable battery when the latest value of the battery information of the rechargeable battery under charge becomes maximum and exceeds the value of the battery information of the rechargeable battery ranked second up to the exceeding amount; and
charging the rechargeable battery having the minimal value of the battery information in the latest sorting.

7. The method according to claim 6, wherein the battery information is state of charge or voltage.
